(19) United States
(12) Patent Application Publication
(10) Pub. No.: US 2007/0165871 A1
(43) Pub. Date: Jul. 19, 2007

(54) Audio system having reverberation reducing filter

(75) Inventors: David Antoine Christian Marie Roovers, Eindhoven (NL); Bahaa Eddine Sarroukh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,766

(22) PCT Filed: Dec. 20, 2004
(86) PCT No.: PCT/IB04/52856

§ 371 Date: Jun. 23, 2006

(30) Foreign Application Priority Data
Jan. 7, 2004 (EP) 04100023.3

(51) Int. Cl. H04B 3/20

(52) U.S. Cl. 381/66

(57) ABSTRACT

A system (1) is described which is suited for suppressing audio distortion. The system comprises echo cancelling means g₁, g₂ coupled between an audio output (4) and a distorted desired audio sensing microphone array (3), and a filter arrangement (7) coupled to the echo cancelling means g₁, g₂ and/or the microphone array (3). The filter arrangements' coefficients represent reverberation distortion in the desired audio sensed by the microphone array (3).

The present invention relates to a system for suppressing audio distortion, comprising:
echo cancelling means coupled between an audio output and a distorted desired sound sensing microphone array, and
a filter arrangement coupled to the echo cancelling means and/or the microphone array.

The present invention also relates to a filter arrangement for application in the system and to a method of suppressing audio distortion.

Such a system is known from WO 97/45995. The known audio system comprises an adaptive echo cancelling filter for removing echoes emanating between a systems' loudspeaker output and a microphone. The known system has a filter arrangement coupled to the echo cancelling filter and the microphone for spectrally suppressing echo components in the microphone signal that were not removed by the echo cancelling filter. One microphone senses a desired audio signal, while the other microphones only receive interfering distortions of the desired signal. The system may have a filter arrangement coupled to the echo cancelling means and/or the microphone array for spectrally suppressing distortion in the form of additional audio noise interference.

It is a disadvantage of the known system that it can not effectively be used for also reducing reverberant distortions in a desired audio signal sensed by a microphone array.

Therefore it is an object of the present invention to provide an improved system and filter arrangement therein for also suppressing echo distortion in the form of echo tail part reverberation in an audio signal sensed by a microphone array.

Thereto in the system according to the invention the filter arrangement includes filter coefficients representing reverberation distortion in the desired audio sensed by the microphone array.

The known echo cancelling means remove only a first part of the acoustic echo from the microphone array signals. The echo emanates between the audio output and each of the microphones, and the first part thereof generally comprises direct audio or sound and first room reflections. However-second part, that is-reverberant echo components are not removed by the echo cancelling means but are in the system according to the invention at least reduced by the filter arrangement, which includes filter coefficients which comprise a measure for reverberation distortion in the desired audio sensed by the microphone array. In addition it appeared that large microphone spacings which are not always feasible in practise are not required for the second part reverberation reduction to be effective.

It is an advantage of the present invention that not only reverberant components of the acoustic echo emanating from the audio output, but also reverberant components of a desired audio signal sensed by the microphone array are effectively reduced by the system according to the present invention.

An embodiment of the system according to the invention allowing design flexibility is characterised in that the filter arrangement includes a beamformer having at least a filter and sum beamformer and/or a delay and sum beamformer.

Most often a combination of filter, sum and delay elements is also used to form the so called Generalised Sidelobe Canceller. Advantageously an additional delay element may be added to the filter arrangement for further improving the performance of the system according to the invention.

A further embodiment of the system according to the invention is characterised in that the filter arrangement is arranged to be adaptive to the reverberation distortion and/or the desired audio signal sensed by the microphone array.

In that case the filter coefficients can be updated, to include a dynamic aspect in the cancelling of varying reverberation, instead of representing a more or less fixed model of the room. Now reverberation can also be suppressed in relation to the respective varying positions and directions of the array microphones.

A still further embodiment of the system according to the invention is characterised in that the system is arranged for updating the filter coefficients in case the reverberation not cancelled by the echo cancelling means dominates the audio signal sensed by the microphone array.

Advantageously the filter coefficients of the filter arrangement are not updated when the desired audio source dominates the array sensed audio signals, thus avoiding the risk of unwanted distortion or even cancellation of the desired audio signal in the output of the filter arrangement.

Another embodiment of the system according to the invention is characterised in that the system is arranged for updating the filter coefficients during a training session.

In the alternative—not requiring such a training session—the system is characterised in that it is provided with automated filter coefficient update control means at least to be coupled to the filter arrangement.

An elaboration of the system according to the invention is characterised in that the filter arrangement has an output, and that the system comprises output echo canceller means coupled between the filter output and the audio output.

Any remaining reverberation not cancelled by the beamformer or the echo cancelling means is now cancelled by the output echo canceller means.

A further elaboration of the system according to the invention is characterised in that the automated filter coefficient update control means are further coupled to the output echo canceller means for controlling the update speed of the filter arrangement.

The output echo cancelling means apart from cancelling remaining echoes can advantageously also be used to provide a measure for any remaining reverberation level in order to compare that level with the level of other sensed sound sources in order to use the result of the comparison as a quantity for controlling the update speed of the filter arrangement.

Another further embodiment of the system according to the invention is characterised in that each microphone of the microphone array has its individual echo cancelling means.

By applying individualised echo cancelling means for each microphone of the array any separate direct echoes and reflections in the first part of any of sensed array signals are cancelled individually as much as possible, while combined remaining reverberation in the tail part is dealt with by the filter arrangement and/or the output echo cancelling means.

At present the system and filter arrangement according to the invention will be elucidated further together with their additional advantages, while reference is being made to the appended drawing, wherein similar components are being referred to by means of the same reference numerals. In the drawing:

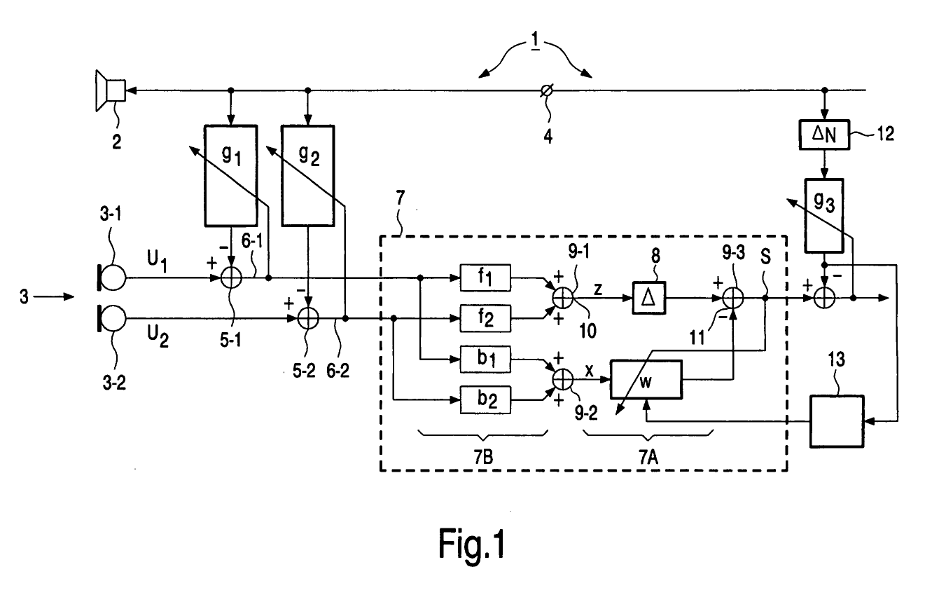

FIG. 1 shows an overview including possible embodiments of the system according to the invention;

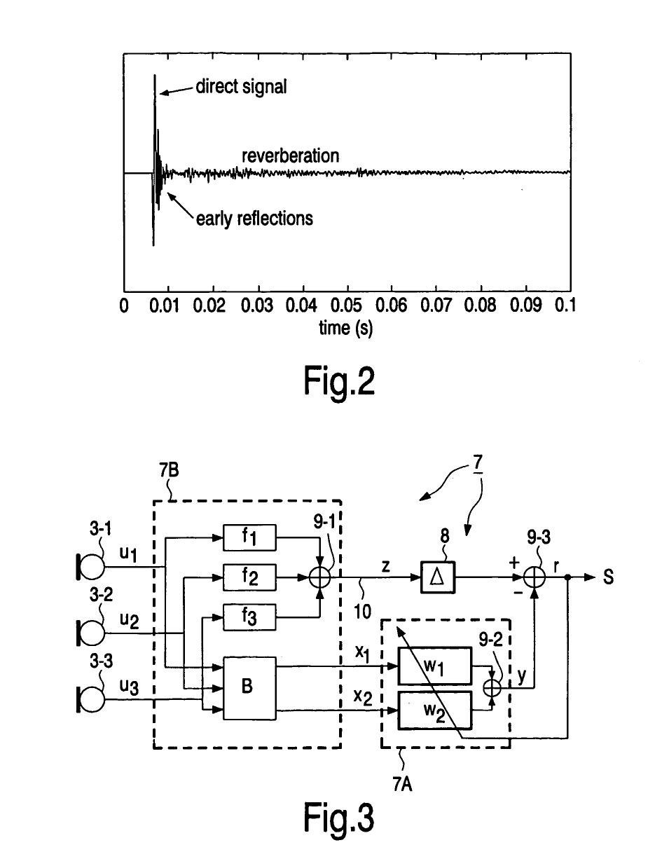

FIG. 2 shows the direct signal, the early reflections and the later arising reverberation tail of a typical room impulse response as a function of time; and

FIG. 3 shows a filter arrangement embodiment according to the invention in the form of a generalised sidelobe canceller having an array of three microphones for application in an extension of the system of FIG. 1.

FIG. 1 shows a system 1, which is suited for suppressing audio distortion in a desired signal. The system as shown has a loudspeaker 2 and a microphone array 3 comprising two microphones 3-1, 3-2. An audio output signal on output 4 is reproduced by the loudspeaker 2. A near end source (not shown) generates desired speech, which is received by the array 3 as a desired speech signal. In addition the array 3 senses —as clarified in FIG. 2—as part of different kinds of distortions apart from noise, a direct signal from the loudspeaker 2 to the array 3, echoes in the form of early—first part—reflections and after some exponential decay later—second part—reflections in the form of so called reverberation shown as a reverberating tail of a typical room impulse response as a function of time. Each microphone 3-1, 3-2 may have its associated echo canceller g₁, and g₂ respectively coupled between the audio output 4 and the distorted desired audio sensing microphone array 3. If at all possible hardware and/or software parts of the echo cancelling means gᵢ(i=1, 2 for two microphones) may be used in common in order to save costs. Each of the echo cancellers gᵢ simulate the path from the loudspeaker 2 to a respective microphone 3 in order to cancel the effects of at least the direct signal and the early reflections, that is the first part of the echo. The technique accomplishing that is for example known from WO 97/45995, whose disclosure is incorporated herein by reference thereto. The respective echo cancelling means may be implemented in various ways, such as with Least Mean Squares (LMS), Recursive Least Squares or Frequency Domain Adaptive Filter using Block LMS techniques.

The respective echo cancelling means gᵢ are coupled to two microphones 3-1, 3-2 of the array 3 through schematically shown subtractors 5-1, and 5-2 each having outputs 6-1, 6-2. These subtractor outputs 6-1 and 6-2 carry respective echo cancelled signals.

The system has a filter arrangement 7, which may include a beamformer 7B, which is coupled through the subtractors 5 to the echo cancelling means gᵢ and/or to the microphone array 3. The beamformer 7B, which is included in a generally called Generalised Sidelobe Canceller, is capable of defining and controlling an audio microphone sensitivity lob or curve. Given the in this case two beamformer input signals on the subtractor outputs 6-1, 6-2, these signals comprise the desired audio/sound/speech signal and a reverberation signal originating from the reverberating tail. The beamformer 7B is capable of discriminating the reverberation signal by deriving a primary signal z including the desired signal and a reference signal x which includes the reverberation. It does this here by filtering in filters f₁, and f₂, as shown, and then summing in summing device 9-1 the filters fᵢ outputs to reveal the primary signal. This way the echo cancelled microphone signals u₁ and u₂ are added such that remaining direct signals and early reflections of the desired audio are coherently summed, which increases the beamformers performance. Furthermore it does this here by filtering the echo cancelled microphone signals in blocking filters b₁ and b₂ and then by summing in device 9-2 the filters' outputs to reveal a reverberation representing reference signal x. The reference signal x virtually contains no desired signal components. The filters bᵢ together B, are called the blocking matrix. The filters fᵢ and bᵢ carry the directional, that is the desired sources dependent information. These filters may also be fixed or adaptive.

In the case as shown in FIG. 3 the beamformer 7B has one delay element 8 coupled to output 10 of device 9-1 followed by a summing device 9-3. The delay element 8 provides a non causal part to the beamformers' impulse response which appeared to improve its performance. The reference signal x is fed to an adaptive filter, indicated w in FIG. 1, whose output signal is fed to an inverting input 11 of device 9-3. The filter w of the filter arrangement 7 comprises the filter coefficients which represent or contain a measure for the reverberation—second part—distortion in the desired audio sensed by the microphone array 3. The summing device 9-3 also has a summed or beamformer output S used to adapt the filter coefficients in the adaptive filter w of the thus adaptive filter arrangement 7, such that their coefficient values represent the varying reverberation distortion. In a non adaptive embodiment the filter coefficients would be fixed to then cancel a then presumed fixed reverberation tail.

Because the filtered reverberation or reference signal on inverting input 11 is subtracted from the primary signal in summing device 9-3 its signal on the summed output S only contains the desired signal, with the reverberating tail being cancelled.

In order to adapt or update the filter coefficients, only the reverberant behaviour of the room needs to taken into account. Thereto the desired audio source is not required, as any source in the room would do that job. One possibility is to only update the filter coefficients if the reverberation on the audio output 4 dominates the array 3 sensed reverberation. Another possibility is to update the filter coefficients during a training session.

In a further embodiment the system 1 comprises output echo canceller means g₃ coupled between the beamformer output S and to the audio output 4, in this case through delay means 12 providing a delay of N samples corresponding with the direct signal and the early reflections already removed by the echo cancelling means gᵢ. If the system 1 is provided with automated beamformer coefficient update control means 13 these means will be coupled to the beamformer 7 and to the output echo canceller means g₃ for controlling the update speed of the filter w. The update speed of the filter w may for example be controlled by a measurement of the reverberant echo level relative to the level of other audio or sound sources that may be present in the room. Such measurement is preferably performed in both the time and frequency domain in order to control the update speed of the filter arrangement 7 accordingly.

FIG. 3 shows an embodiment of a filter arrangement 7 having an array of three microphones 3-1, 3-2, 3-3. Essentially a plurality of microphones is possible. However above outlined principles remain the same. Block matrices may be grouped into one block B. Different reference signals x₁ and x₂ may be fed to the filter 7A, here comprising generally adaptive individualised filters w₁ and w₂. At wish delay elements Δ may be divided up in front or after the filters f₁, f₂, and f₃ coupled to the respective three microphones 3. Separate delay elements Δ could be included in the respective branches from possibly each of the microphones to summing device 9-1 to account for expected individual delays between loudspeaker 2 and microphone 3.

If the system 1 does not start up by itself, due to absence of any far end signal a loudspeaker signal could be generated, e.g. a noise sequence or some kind of start up tune.

The system explained above can for example be used in hands-free communication systems, such as hands-free speakerphones, voice controlled systems for example in home or for medical applications, congress systems, dictation system or the like.

1. A system (1) for suppressing audio distortion, comprising:
echo cancelling means (g₁, g₂) coupled between an audio output (4) and a distorted desired audio sensing microphone array (3), and
a filter arrangement (7, 7A) coupled to the echo cancelling means (g₁, g₂) and/or the microphone array (3), the filter arrangement including filter (7A) coefficients (w; w₁, w₂) representing reverberation distortion in the desired audio sensed by the microphone array (3).

2. The system (1) according to claim 1, wherein the filter arrangement (7) includes a beamformer (7B) having at least a filter and sum beamformer and/or a delay and sum beamformer.

3. The system (1) according to claim 1, wherein the filter arrangement (7A) is arranged to be adaptive to the reverberation distortion and/or the desired audio signal sensed by the microphone array (3).

4. The system (1) according to claim 1, wherein the system (1) is arranged for updating the filter (7A) coefficients (w; w₁, w₂) in case the reverberation not cancelled by the echo cancelling means (g₁, g₂) dominates the audio signal sensed by the microphone array (3).

5. The system (1) according to claim 1, wherein the system (1) is arranged for updating the filter (7A) coefficients (w; w₁, w₂) during a training session.

6. The system (1) according to claim 1, wherein the system (1) is provided with automated filter coefficient update control means (13) coupled to at least the filter arrangement (7A).

7. The system (1) according to claim 1, wherein the filter arrangement (7) has an output (S), and the system (1) comprises output echo canceller means (g₃) coupled between the filter output (S) and the audio output (4).

8. The system (1) according to claim 7, wherein the automated filter coefficient update control means (13) are further coupled to the output echo canceller means (g₃) for controlling the update speed of the filter arrangement (7).

9. The system (1) according to claim 1, wherein each microphone (3-i, i=1, 2, . . . n) of the microphone array (3) has its individual echo cancelling means (gᵢ, i=1, 2, . . . n).

10. A filter arrangement (7) for use in the system (1) according to claim 1.
